(19) United States
(12) Patent Application Publication
(10) Pub. No.: US 2026/0044763 A1
(43) Pub. Date: Feb. 12, 2026

(54) LEARNING QUANTUM SYSTEMS VIA OUT-OF-TIME-ORDERED CORRELATORS

(71) Applicant: Google LLC, Mountain View, CA (US)

(72) Inventors: Thomas Steven Schuster, Berkeley, CA (US); Masoud Mohseni, Calabasas, CA (US); Yuezhen Niu, El Segundo, CA (US)

(21) Appl. No.: 18/995,691

(22) PCT Filed: Jul. 19, 2023
(86) PCT No.: PCT/US2023/028140

§ 371 Date: Jan. 16, 2025

Related U.S. Application Data
(60) Provisional application No. 63/390,514, filed on Jul. 19, 2022.

(51) Int. Cl. G06N 10/20; G06N 10/40; G06N 10/60

(52) U.S. Cl. CPC G06N 10/20; G06N 10/40; G06N 10/60

(57) ABSTRACT

Methods, systems, and apparatus for learning quantum systems via out-of-time-ordered correlators. In one aspect, a method includes measuring, by a control and measurement system, an out-of-time-ordered correlator value for a quantum system that includes a plurality of qubits, where the plurality of qubits comprises a probe qubit and one or more other qubits. To measure the out-of-time-ordered correlator value, the probe qubit is prepared in an initial state. Forward time evolution is performed on the quantum system for a time t. A unitary operator is applied to one or more qubits in the quantum system. Backward time evolution is performed on the quantum system for the time t, and the probe qubit is measured to obtain the out-of-time-ordered correlator value. A classical computing device processes the measured out-of-time-ordered correlator value to determine properties of the quantum system.

### BACKGROUND

This disclosure relates to quantum computing.

Learning properties of quantum systems poses challenges not present in their classical counterparts. These challenges often stem from the existence of entanglement-measurements of a quantum system that is highly entangled with another system (or the environment) reveal little information from which to learn. In practical settings, these difficulties are most commonly encountered in strongly-interacting quantum systems. Strong interactions can introduce non-local entanglement across the system at very short time scales, and are found to thereby inhibit the learning of system properties (e.g. the Hamiltonian) from physical observables.

The ubiquity of strong interactions in experimental applications of quantum learning has spurred a variety of solutions to this problem. For instance, in nuclear magnetic resonance (NMR) spectroscopy, technologies have been developed to controllably dampen undesired strong interactions between solid-state nuclear spins, which has enabled the identification of hitherto inaccessible molecular structures. Similarly, in quantum device characterization and quantum sensing, dynamical decoupling control sequences can effectively eliminate unwanted interactions and improve learning of the residual interactions. Other approaches include learning by transducing quantum data from the system onto a quantum simulator, or learning from high-precision local measurements at early times, before entanglement has formed. Nonetheless, owing to incomplete control or limited experimental precision, many physical systems remain un-learnable with existing approaches.

### SUMMARY

This disclosure describes learning properties of quantum systems via out-of-time-ordered correlators.

In general, one innovative aspect of the subject matter described in this specification can be implemented in a method that includes measuring, by a measurement control system, an out-of-time-ordered correlator value for a quantum system comprising a plurality of qubits, wherein the plurality of qubits comprises a probe qubit and one or more other qubits, the measuring comprising: preparing the probe qubit in an initial state, performing forward time evolution on the quantum system for a time t, applying a unitary operator to one or more qubits in the quantum system, performing backward time evolution on the quantum system for the time t, and measuring the probe qubit to obtain the out-of-time-ordered correlator value; and processing, by a classical computing device, the measured out-of-time-ordered correlator value to determine properties of the quantum system.

Other implementations of these aspects includes corresponding computer systems, apparatus, and computer programs recorded on one or more computer storage devices, each configured to perform the actions of the methods. A system of one or more classical and quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations the measured out-of-time-ordered correlator value indicates whether information encoded at the probe qubit at an initial time is contained in correlations involving the other qubits at time t.

In some implementations the method further comprises, for each of multiple values of t and for each of multiple unitary operators, repeatedly measuring the out-of-time-ordered correlator value.

In some implementations processing the measured out-of-time-ordered correlators values to determine properties of the quantum system comprises using a trained classical learning model to predict the properties of the quantum system.

In some implementations the method further comprises generating, by a quantum computer, training data, the generating comprising performing quantum simulations of a Hamiltonian that characterizes the quantum system, each quantum simulation corresponding to respective Hamiltonian parameter values; and training the classical learning model to predict properties of the quantum system using the training data.

In some implementations the method further comprises the out-of-time-ordered correlator value for each of multiple values of t and for each of multiple unitary operators, wherein the measurements are performed at a first precision; computing the Fisher information for each measured out-of-time-ordered correlator value; and repeating measurement of the out-of-time-ordered correlator values with maximal Fisher information, wherein the repeated measurements are performed at a second precision that is higher than the first precision.

In some implementations the unitary operator comprises a local unitary operator, optionally a single qubit Pauli operation.

In some implementations the unitary operator comprises a global rotation operation.

In some implementations the quantum system comprises an ergodic 1D spin chain, and wherein determining properties of the quantum system comprises learning a qubit coupling at a distance d from the probe qubit.

In some implementations the quantum system comprises two spin chains that intersect at a distance d from the probe qubit, and wherein determining properties of the quantum system comprises learning the value of d.

In some implementations performing forward time evolution on the quantum system for a time t comprises applying a quantum circuit to the quantum system that implements a second unitary operator e^{-iHt}, wherein H represents a Hamiltonian that characterizes the quantum system, and wherein performing backward time evolution on the quantum system for the time t comprises applying a quantum circuit to the quantum system that implements a third unitary operator e^{iHt}.

In some implementations performing backward time evolution on the quantum system for the time t is noisy

In general, another innovative aspect of the subject matter described in this specification can be implemented in a method that includes measuring, by a measurement control system, an out-of-time-ordered correlator value for a quantum system comprising a plurality of interacting qubits, the measuring comprising: preparing a first qubit and a second qubit in the quantum system in an initial state, wherein the first qubit is adjacent to the second qubit, performing forward time evolution on the quantum system for a time t, applying a unitary operator to the first qubit, performing backward time evolution on the quantum system for the time t, and measuring the first qubit and the second qubit to obtain the out-of-time-ordered correlator value; and processing, by a classical computing device, the measured out-of-time-ordered correlator value to determine properties of the quantum system.

Other implementations of these aspects includes corresponding computer systems, apparatus, and computer programs recorded on one or more computer storage devices, each configured to perform the actions of the methods. A system of one or more classical and quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations the measured out-of-time-ordered correlator value indicates whether information encoded at the first qubit at an initial time is contained in correlations involving other qubits at time t.

In some implementations the method further comprises, for each of multiple values of t and for each of multiple pairs of qubits in the quantum system, repeatedly measuring the out-of-time-ordered correlator value.

In some implementations processing the measured out-of-time-ordered correlator values to determine properties of the quantum system comprises using a trained classical learning model to predict the properties of the quantum system.

In some implementations the method further comprises generating, by a quantum computer, training data, the generating comprising performing quantum simulations of a Hamiltonian that characterizes the quantum system, each quantum simulation corresponding to respective Hamiltonian parameter values; and training the classical learning model to predict properties of the quantum system using the training data.

In some implementations the method further comprises measuring the out-of-time-ordered correlator value for each of multiple values of t and for each of multiple pairs of qubits, wherein the measurements are performed at a first precision; computing the Fisher information for each measured out-of-time-ordered correlator value; and repeating measurement of the out-of-time-ordered correlator values with maximal Fisher information, wherein the repeated measurements are performed at a second precision that is higher than the first precision.

In some implementations the quantum system comprises a strongly interacting system.

In some implementations the quantum system comprises a 1D spin chain, and wherein determining properties of the quantum system comprises characterizing a weak link interaction known to exist in the spin chain.

In some implementations the method further comprises repeatedly measuring the out-of-time-ordered correlator value for pairs of qubits that are within a predetermined distance from the weak link interaction.

In some implementations the method further comprises, prior to processing the measured out-of-time-ordered correlator values: computing the mutual information between each measured out-of-time-ordered correlator values and link strength; selecting a predetermined number measured out-of-time-ordered correlator values with the highest mutual information; and providing the selected predetermined number of measured out-of-time-ordered correlator values for processing by the classical computing device.

In some implementations the quantum system comprises a 1D spin chain, and wherein determining properties of the quantum system comprises predicting whether the spin chain includes or excludes a weak link interaction.

In some implementations performing backward time evolution on the quantum system for the time t is noisy.

In some implementations performing forward time evolution on the quantum system for a time t comprises applying a quantum circuit to the quantum system that implements a second unitary operator e^{-iHt}, wherein H represents a Hamiltonian that characterizes the quantum system, and wherein performing backward time evolution on the quantum system for the time t comprises applying a quantum circuit to the quantum system that implements a third unitary operator e^{iHt}.

The subject matter described in this specification can be implemented in particular embodiments so as to realize one or more of the following advantages.

Learning the properties of dynamical quantum systems underlies applications ranging from nuclear magnetic resonance spectroscopy to quantum device characterization. A central challenge in this pursuit is the learning of strongly-interacting systems, where conventional observables decay quickly in both time and space, limiting the information that can be learned from their measurement. The present disclosure introduces a new class of observables into the context of quantum learning-out-of-time-ordered correlators-which substantially improve the learnability of strongly interacting systems by virtue of displaying informative physics at large times and distances.

The presently described techniques are described in the context of two general scenarios in which out-of-time-ordered correlators provide a significant advantage for learning tasks in local Hamiltonian systems. The first scenario is related to situations where experimental access to the system is spatially-restricted, for example via a single “probe” degree of freedom (qubit). The second scenario is related to detecting weak interactions (in an otherwise strongly-interacting system), whose strength is much less than the typical interaction strength and which thus manifest only at late times. The advantages achieved by the presently described techniques can be characterized using information theoretic measures (the Fisher information) and performance metrics across a variety of learning problems. Further, the advantages are robust to both experimental read-out error and time-reversal imperfections that arise from strong coupling with an environment or decoherence.

Further, nearly all techniques for time-reversal rely only on the type of interaction being reversed, and require no knowledge of the magnitudes of interactions (e.g., which is to be learned). Learning via out-of-time-ordered correlators can therefore find applications across diverse physical contexts. Examples include learning long-range cross-talk in quantum processors and strongly-interacting problems in NMR.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for learning quantum systems using out-of-time-ordered correlators.

FIG. 2 is a flow diagram of an example process for learning in quantum systems with restricted access.

FIG. 3 shows two plots for learning in quantum systems with restricted access using out-of-time-ordered correlators.

FIG. 4 is a flow diagram of an example process for detecting weak interactions in a quantum system.

FIG. 5 shows two plots for learning weak interactions in quantum systems.

FIG. 6 is a circuit diagram of a solution to the disjoint unitary problem using out-of-time-ordered correlator measurements.

FIG. 7 depicts an example classical/quantum computer.

### DETAILED DESCRIPTION

This specification describes learning quantum systems and their properties via out-of-time-ordered correlators. A time-ordered correlator (TOC) is a correlation function that takes the general form given by Eq. (1) below,

$${C}_{TOC} = t r ( {A}_{k} ( {t}_{k} ) … {A}_{1} ( {t}_{1} ) ρ {B}_{1} ( {t}_{1}^{l} ) … {B}_{l} ( {t}_{l}^{′} ) ) \qquad ( 1 )$$

where the operators A, B increase in time away from the initial density matrix ρ, that is tₖ> . . . >t₁ and t′ₗ> . . . >t′₁. Time-ordered correlators can be measured by evolving the state ρ forward in time (e.g. via Hamiltonian evolution O(t)=e^{iHT}Oe^{-iHt}) while applying intermediary quantum operations at each time

$${t}_{i} , {t}_{j}^{′} .$$

Any correlation function that does not obey this form is called an out-of-time-order correlator. A common example of a TOC is the two-point function given by Eq. (2) below,

$${C}_{TOC} = 〈 {V}_{x} ( t ) {W}_{{x}^{′}} ( 0 ) 〉 \qquad ( 2 )$$

where [symbol] ⋅ [symbol] ≡tr(⋅)/2^{L} denotes the infinite temperature trace for L qubits, and Vₓ, Wₓ, are local operators at sites x, x′. Throughout the present disclosure, time-evolved operators such as V(t) are denoted as V(t)=U(t, 0)VU(t, 0)^{†} where the time-evolution unitary is

$$U ( {t}_{2} , {t}_{1} ) = 𝒯 \{ {e}^{- i {\int }_{{t}_{1}}^{{t}_{2}} dtH ( t )} \}$$

and H(t) is a time-dependent Hamiltonian that characterizes the quantum system. In some implementations H(t) can be a Floquet Hamiltonian. Such correlators measure the spread of local quantities in space and time, e.g., how much spin prepared at site, x′ at time zero has transferred to site x at time t. It has been shown that local TOCs typically decay quickly, i.e. in O(1) times, to their thermal values. This quick decay can inhibit learning tasks, since no additional information can be acquired from the TOC at times after the decay has occurred.

An example out-of-time-order correlator (OTOC) is the four-point correlation function given by Eq. (3) below,

$${C}_{OTOC} = 〈 {V}_{x} ( t ) {W}_{{x}^{′}} ( 0 ) {V}_{x}^{†} ( t ) {W}_{{x}^{′}} ( 0 ) 〉 \qquad ( 3 )$$

where Vₓ, Wₓ, represent local operators. Unlike time-ordered measurements, both forward and backward time-evolution is typically required to measure OTOCs. That is, for a given evolution of the system “forward” in time, a reversed evolution considered to be “backward” can also be applied in order to successfully measure OTOCs. For the applications described in this specification, nearly all experimental techniques for time-reversal rely only on the type of interaction being reversed and require no knowledge of the specific Hamiltonian, which one might wish to learn. For example, the same pulse sequence reverses an arbitrary dipole-dipole coupling Hamiltonian in an NMR experiment. Physically, the OTOC probes whether information encoded at site x′ at time zero is contained in correlations involving site x at time t. This is quantified by the squared commutator of a time-evolved operator at x with a local operator at x′, [symbol] |[Vₓ(t), W_{x′} (0)]|² [symbol] =1−C_{OTOC}. In local strongly-interacting systems, operators are expected to spread ballistically according to the connectivity of the system. This spread continues for a duration proportional to the system's spatial extent˜L by which time the information has been delocalized across the entire system.

This phenomenology leads to two central intuitions for learning from OTOCs. First, the dynamics of the OTOC contain information primarily about the connectivity of the system under study. Second, the OTOC continues to reveal such information up to O(L) times, long after TOCs have decayed. This timescale increases as the system size increases.

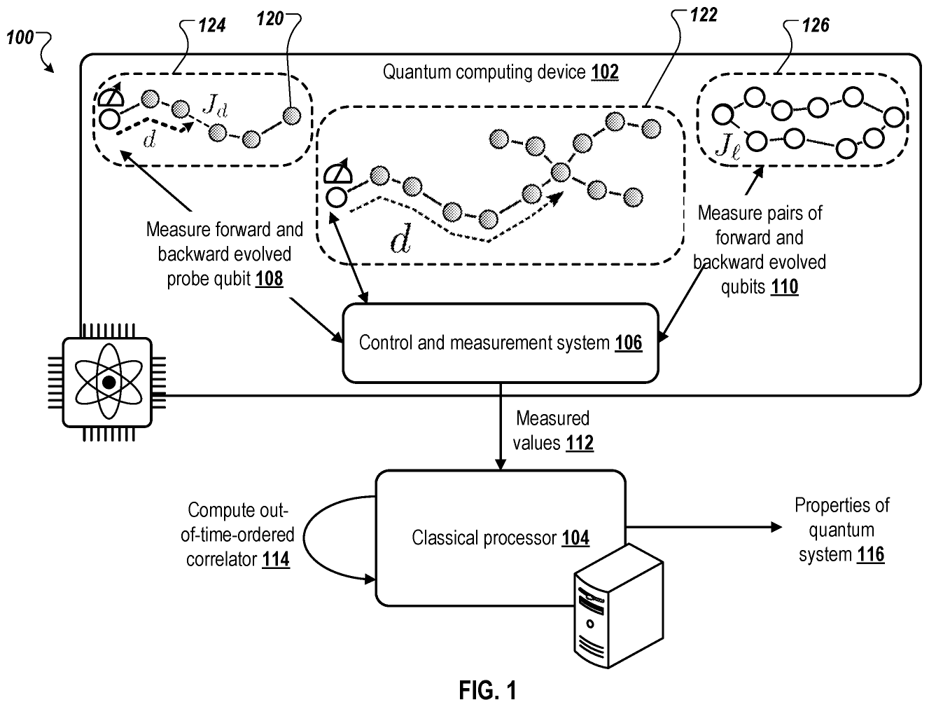

FIG. 1 is a block diagram of an example system 100 for learning quantum systems using out-of-time-ordered correlators (OTOCs). The example computing system 100 is an example of a system implemented as classical and quantum computer programs on one or more classical computers and quantum computing devices in one or more locations, in which the systems, components, and techniques described herein can be implemented.

The example computing system 100 includes a quantum computing device 102 and a classical processor 104. For illustrative purposes, the quantum computing device 102 and classical processor 104 shown in FIG. 1 are illustrated as separate entities, however in some implementations the classical processor 104 may be included in the quantum computing device 102. For example, in some implementations the quantum computing device 102 can be directly connected to the classical processor 104. In other implementations, the quantum computing system 102 can be connected to the classical processor 104 through a network, e.g., a local area network (LAN), wide area network (WAN), the Internet, or a combination thereof.

The quantum computing device 102 includes physical components for performing quantum computation. For example, the quantum computing device 102 can include a quantum data plane that, in turn, includes multiple physical qubits, e.g., qubit 120, and a control and measurement system 106 that is configured to perform operations and measurements on the physical qubits. Although not shown in FIG. 1, the quantum computing device 102 can further include a control processor plane that is configured to determine sequences of operations and measurements that a quantum algorithm being performed by the quantum computing system requires and a classical computer that is in data communication with the control processor and facilitates user interactions and access to networks or storage. The particular type of the quantum computing device 102 can depend on the type of qubit used. In some implementations the qubits can be superconducting qubits, semiconducting qubits, photonic qubits, or atom-based qubits. For example, the qubits can include Xmon qubits, flux qubits, phase qubits. CAT qubits, or qubits with frequency interactions.

The classical processor 104 includes components for performing classical computations. For example, the classical processor 104 can be implemented as one or more computer programs, i.e., one or more modules of computer program instructions encoded on a tangible non-transitory storage medium for execution by, or to control the operation of, a data processing apparatus. The computer storage medium can be a machine-readable storage device, a machine-readable storage substrate, a random or serial access memory device, or a combination of one or more of them.

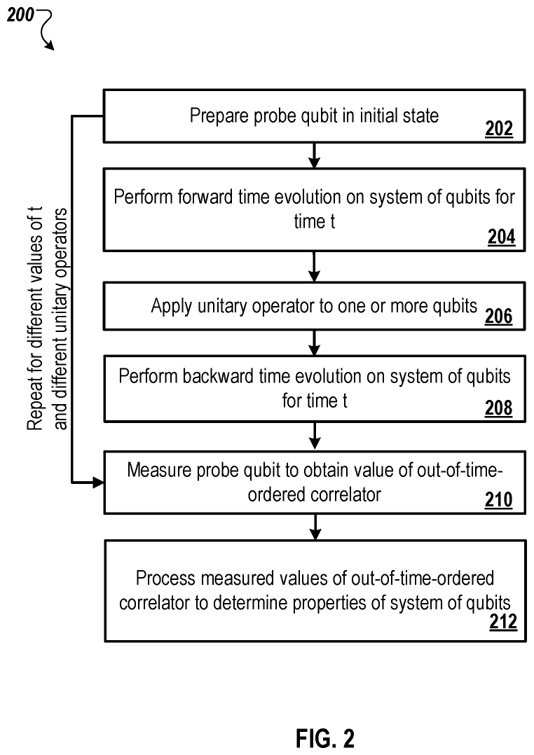

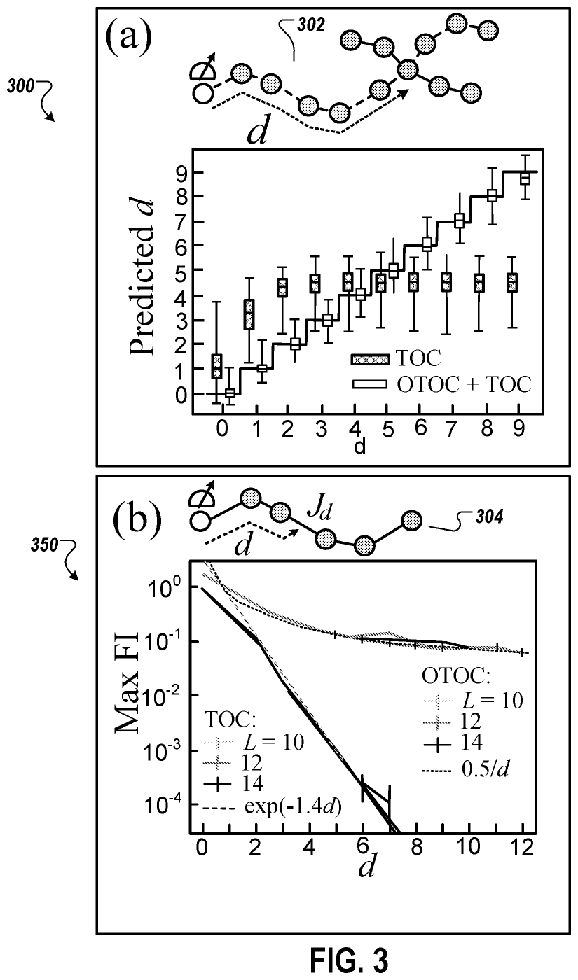

The example system 100 is configured to perform operations to learn quantum systems and their properties using OTOCs. For example, in some implementations the system 100 can use OTOCs to learn properties of quantum systems with restricted access, e.g., to determine a distance d between a probe qubit and an intersection of two spin chains as shown in box 122 of FIG. 1 or to determine a strength of an interaction between two qubits that are a distance d away from a probe qubit as shown in box 124 of FIG. 1. In these examples, the control and measurement system 106 can be configured to implement a measurement protocol that implements both forward and backward evolution of the probe qubit 108 to obtain measured values 112 that, when provided to the classical processor 104, can be used to compute OTOCs 114 and learn the properties of the quantum system 116 (which can be provided as output). Example operations performed by the quantum computing device 102 and the classical processor 104 to learn properties of quantum systems with restricted access are described in more detail below with reference to FIGS. 2 and 3.

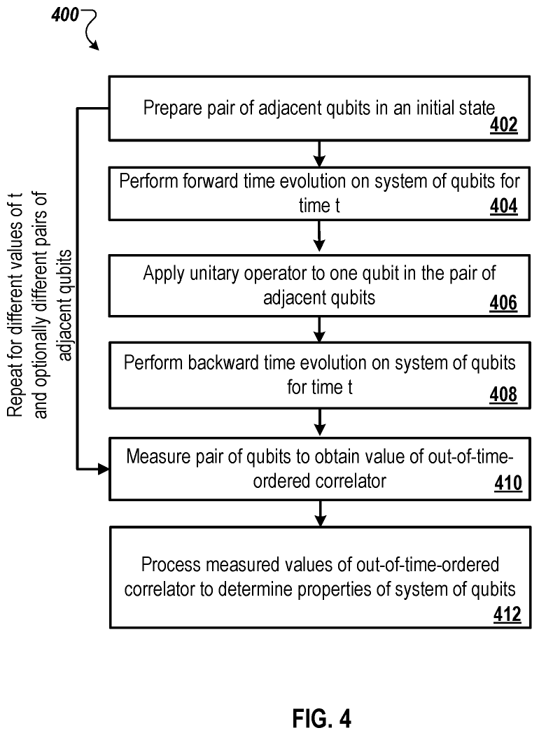

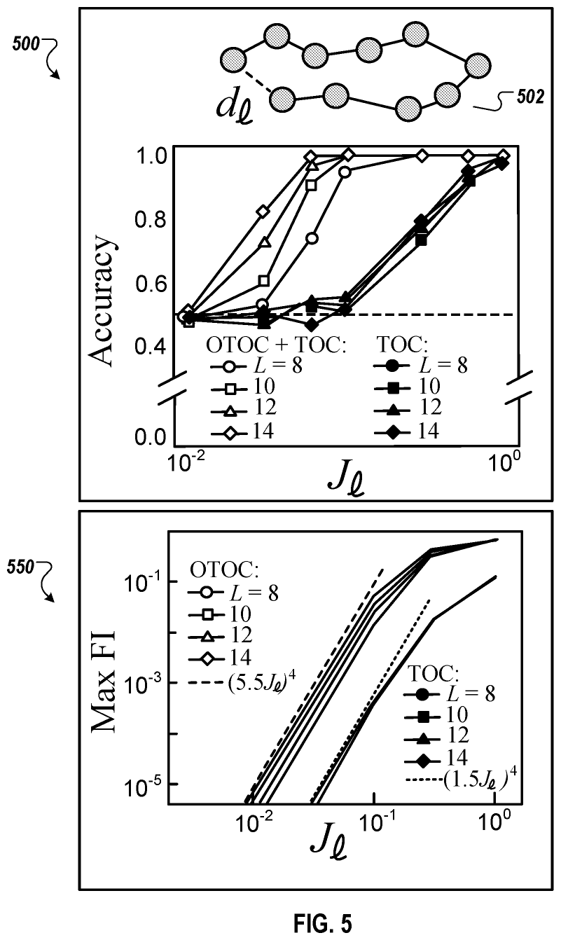

As another example, in some implementations the system 100 can use OTOCs to learn or characterize weak interactions in a quantum system, e.g., to determine whether two qubits in the quantum system interact or not as shown in box 126 of FIG. 1. In these examples, the control and measurement system 106 can be configured to implement a measurement protocol that implements both forward and backward evolution of pairs of qubits 110 to obtain measured values 112 that, when provided to the classical processor 104, can be used to compute OTOCs 114 and learn the properties of the quantum system 116 (which can be provided as output). Example operations performed by the quantum computing device 102 and the classical processor 104 to learn or characterize weak interactions are described in more detail below with reference to FIGS. 4 and 5.

Learning with Restricted Access

FIG. 2 is a flow diagram of an example process 200 for learning in quantum systems with restricted access. For example, example process 200 can be applied to settings where experimental access to the quantum system includes state preparation and read-out capabilities but is spatially restricted over a single probe qubit that interacts with a larger system that is to be learned (e.g., an experimentalist only has local unitary control over the qubits in the quantum system). For convenience, the example process 200 will be described as being performed by a system of one or more classical and quantum computing devices located in one or more locations. For example, the system 100 of FIG. 1, appropriately programmed, can perform example process 200.

The system measures, by a measurement control system, a value of an out-of-time-ordered correlator for a quantum system that includes multiple qubits. The quantum system includes a probe qubit (which can be directly accessed) and one or more other qubits. In some implementations, e.g., in NMR and solid-state defect setups, the quantum system can be initially prepared in an infinite temperature (i.e. maximally mixed) state. The value of the out-of-time-ordered correlator indicates whether information encoded at the probe qubit at an initial time is contained in correlations involving the other qubits at a later time t=τ=−τ′.

The OTOC can be given by C_{OTOC}(x, t)= [symbol] Vₚ(t)Wₓ(0)Vₚ(t)Wₓ(0) [symbol] where represents the probe qubit and [symbol] ⋅ [symbol] ≡tr(·)/2^{L} denotes the infinite temperature trace for L qubits. Such OTOCs can be measured using state preparation and read-out on the probe qubit, combined with time-evolution and a single local unitary operation on the larger quantum system. The operators V, W can run over all local operators in the system. For instance, the operators can run over all

$${4}^{w} ( \frac{N}{w} )$$

Pauli operators of a predefined weight≤w, where w˜O(1). This can be achieved by randomized measurement strategies such as shadow tomography with local Clifford unitaries and O(3^{w}) measurements. However, in practice, the operators V, W can be restricted to a subset of possible values. For example, in some implementations V=W∈{σₓ, σ_{z}} for TOCs and V=W∈{σ_{z}} for OTOCs. The OTOC is observed to be relatively insensitive to basis of V and W, therefore the choice can be restricted to a single Pauli operator, e.g., σ_{z} (although it is noted that adding an additional Pauli operator, e.g., σₓ, could only improve the relative advantage of OTOCs compared to TOCs). More broadly, adding additional pairs of {V, W} will likely not change the qualitative behavior of learning via TOCs and OTOCs. Specifically, the learning advantage of OTOCs arises from their ability to detect highly non-local correlations in the system (i.e. large-weight components of the time-evolved operator Vₚ(t)). These correlations are not detectable by any time-ordered correlator involving only few-body operators; indeed, in ergodic systems we generically expect that they are not efficiently detectable by any time-ordered measurement.

To measure the out-of-time-ordered correlator, the system prepares the probe qubit p in an initial state (step 202). The initial state can be an eigenstate of a local operator Vₚ (included in the OTOC) such that the density matrix of the quantum system is given by

$$ρ = \frac{1}{2} ( {𝕀}_{p} + {V}_{p} ) ⊗ \frac{1}{{2}^{L - 1}} {𝕀}_{sys} \qquad ( 4 )$$

where [symbol] ₚ represents an identity operator [symbol] that acts on qubit p, Vₚ represents the operator V that acts on qubit p, L represents the total number of qubits included in the quantum system, and [symbol] _{sys} represents an identity operator II that acts on the entire quantum system.

The system then performs forward time evolution on the quantum system for a time r (step 204). For example, the system can apply a quantum circuit to the quantum system that implements the unitary operator e^{-iHτ}, where H represents a Hamiltonian that characterizes the quantum system.

The system then perturbs the quantum system through application of a unitary operator to one or more qubits included in the quantum system (step 206). In some implementations the unitary operator can be a local unitary operator Wₓ that is applied to qubit x, e.g., a single qubit Pauli operation. In other implementations the unitary operator can be a global rotation operation. The type of unitary operator performed at step 106 is dependent on the type of learning being performed. For example, in some implementations the quantum system can be an ergodic 1D spin chain. In these implementations the learning task can be learning a qubit coupling at a distance d from the probe qubit. As another example, in some implementations the quantum system can include two spin chains that intersect at a distance d from the probe qubit (see, e.g., illustration 302 in FIG. 3). In these implementations the learning task can be to learn the value of d (which represents the geometry of the quantum system) from measurements of the quantum system's correlation functions.

The system then performs backward time evolution on the quantum system for the time τ′ (step 208). That is, the system performs a time-reversed evolution of the quantum system in comparison with the forward time evolution carried out at step 204. For example, the system can apply a quantum circuit to the quantum system that implements the unitary operator e^{iHσ′}. In some implementations the implementation of the backward time evolution may be noisy.

The system then measures the probe qubit to obtain the out-of-time-ordered correlator value (step 210). For example, the system can measure the expectation value of the local operator Vₚ on the probe qubit. In some implementations the system can repeat steps 202-210 for different values of r and for different local or global unitary operators (e.g., different rotation angles) to obtain multiple values of the out-of-time-ordered correlator.

The system processes, by a classical computing device (such as classical processor 104), the measured values of the out-of-time-ordered correlator to determine properties of the quantum system (step 212). In some implementations the system can use a trained classical learning model to process measured values of the out-of-time-ordered correlator and predict properties of the quantum system. For example, the classical learning model can be a support vector machine (SVM) with radial basis functions that has been trained on multiple, e.g., 3000, randomly drawn Hamiltonians to predict the distance d (from the probe qubit) at which two spin chains intersect (as illustrated in FIG. 3). To train the classical learning model the system can generate, by a quantum computing device, training data by performing classical or quantum simulations of the Hamiltonian that characterizes the quantum system to compute correlation functions of an ensemble of Hamiltonians for each value of d. Each quantum simulation corresponds to respective Hamiltonian parameter values. The system can then train the classical learning model using the ensembles to predict properties of the quantum system using the training data, e.g., to predict the unknown Hamiltonian's value of d given its correlation functions.

In some implementations, before processing the measured values of the out-of-time-ordered correlator to determine properties of the quantum system, the system can compute the Fisher information for each measured value of the out-of-time-ordered correlator. The system can then identify one or more correlators that achieve a maximal Fisher information (or correlators with an amount of Fisher information that exceeds a predetermined threshold). The system can then repeat the measurements of the out-of-time-ordered correlator that correspond to the maximal Fisher information, where the repeated measurements are performed at a higher precision.

FIG. 3 shows two plots 300, 350 for learning in quantum systems with restricted access using OTOCS. In both plots, spin systems with disordered on-site fields and dipolar interactions between neighboring spins are considered. The time evolution of the spin systems are simulated using Krylov subspace methods.

The first plot 300 shows results from support vector machine (SVM) regression for learning the distance d in the spin geometry 302, with access to TOCs or both TOCs and OTOCs. In particular, a SVM was trained on 3000 randomly drawn Hamiltonians (300 for each value of d=0, . . . , 9), and its performance tested on 2000 additional Hamiltonians. To reduce the sensitivity of learning to fine-tuned features of the correlation functions, a Gaussian distributed read-out error was to all correlation functions, with mean zero and standard deviation equal to 3%. The model's predictions as a function of the actual value of d are displayed in plot 300. In plot 300, the bars represent 75% (100%) percentiles of predictions on 200 disorder realizations. The step function represents the actual d. As shown, access to OTOCs exponentially improves the learnability of distant features. In particular, learning using OTOCs allows accurate predictions of d within ±1 of its actual value for all distances probed (up to d=9). In contrast, with access to only TOCs, the model performs significantly worse for all d and resorts to nearly random guessing for d≥3.

The second plot 350 shows the Fisher Information (FI) FI(J_{d}|C) of an interaction J_{d} a distance d away from the probe qubit, maximized over all correlators C in a L-qubit 1D chain 304. The FI quantifies the amount of information that a random variable (e.g. a correlation function C measured within some read-out error δ) carries about an unknown parameter (e.g. a coupling strength J), and thereby bounds the ultimate learnability of the parameter. If it is assumed that read-out errors are normally distributed, the FI is a squared derivative

$$FI ( J \vert C ) ≡ {δ}^{2} FI ( J \vert C ; δ ) = {\vert \frac{\partial C}{\partial J} \vert}^{2} ,$$

where the δ-dependence is removed by through the introduction of a factor δ².

In plot 350, the FI in an ergodic 1D spin chain is numerically computed, where a coupling J_{d} lying a distance d away from a probe qubit is to be learned. The same set of correlation functions as specified for the learning task in plot 300 is considered. The maximum Fisher information over all correlation functions (i.e. over all x; t), averaged over 200 and 1000 disorder realizations for TOCs and OTOCs, respectively are plotted. As shown, the maximum FI of TOCs decays exponentially in the distance d from the probe qubit. In contrast, the maximum FI of OTOCs follows a slow algebraic decay ˜1/d thereby achieving a multiple-order of-magnitude advantage over TOCs even at modest distances, d≥3. This algebraic decay arises from the ˜√t broadening of the OTOC wave-front in time.

### Learning Weak Interactions

FIG. 4 is a flow diagram of an example process 400 for detecting weak interactions in a quantum system. In the present disclosure, a weak interaction in a quantum system is an interaction with less strength than other interaction strengths in the quantum system, e.g., a weak interaction in an otherwise strongly interacting system. Unlike in example process 200 described above, in these settings an experimentalist can have non-local unitary control over the qubits in the quantum system, e.g., is capable of measuring all local correlation functions of the quantum system of interest. For convenience, the process 400 will be described as being performed by a system of one or more classical and quantum computing devices located in one or more locations. For example, the system 100 of FIG. 1, appropriately programmed, can perform example process 400.

The system measures, by a measurement control system, a value of an out-of-time-ordered correlator for a quantum system that includes multiple interacting qubits. In some implementations the quantum system can be a strongly interacting system. The value of the out-of-time-ordered correlator indicates whether information encoded at one qubit at an initial time is contained in correlations involving the other qubits at time t.

The out-of-time-ordered correlator can take the form given by Eq. (3) above, where x, x′ run over all qubits included in the quantum system. As described above with reference to FIG. 2, the operators V, W can be given by V=W∈{σₓ, σ_{z}} for TOCs and V=W∈{σ_{z}} for OTOCs. In some implementations the indices x, x′ can span all qubits within a distance 2 of the link—this consists of 6 possible values for each of x, x′, corresponding to distances 0, 1, and 2 to both the left and right of the link. In principle, x, x′ could run over the entire lattice, however, in practice it is observed that correlation functions involving qubits distant from the link provide little information, and so can be safely neglected.

To measure the out-of-time-ordered correlator, the system prepares a first qubit and a second qubit in the quantum system in an initial state, where the first qubit is adjacent to the second qubit (step 402). For example, the system can prepare the first qubit in an eigenstate of a first operator included in the OTOC and the second qubit in an eigenstate of a second operator included in the OTOC, as described above with reference to FIG. 2.

The system then performs forward time evolution on the quantum system for a time t (step 404). For example, the system can apply a quantum circuit to the quantum system that implements the unitary operator e^{-iHt}, where H represents a Hamiltonian that characterizes the quantum system.

The system then perturbs the quantum system through application of a unitary operator to the first qubit (step 406). The type of unitary operator applied at step 406 is dependent on the type of learning being performed. For example, in some implementations the quantum system can be a 1D spin chain. In these implementations the learning task can be predicting whether the spin chain includes or excludes a weak link interaction. As another example, in some implementations the quantum system can be a 1D spin chain and the learning task can be the task of characterizing a weak link interaction known to exist in the spin chain.

The system then performs backward time evolution on the quantum system for the time t (step 408). That is, the system performs a time-reversed evolution of the quantum system in comparison with the forward time evolution carried out at step 404. For example, the system can apply a quantum circuit to the quantum system that implements the unitary operator e^{iHt}. In some implementations the implementation of the backward time evolution may be noisy.

The system then measures the first qubit and the second qubit to obtain the out-of-time-ordered correlator value (step 410). In some implementations the system can repeat steps 402-410 for different values of t and for each of multiple pairs of qubits in the quantum system, e.g., pairs of qubits that are within a predetermined distance from a known weak link interaction, to obtain multiple values of the out-of-time-ordered correlator.

The system processes, by a classical computing device, the measured values of the out-of-time-ordered correlator to determine properties of the quantum system (step 412). In some implementations the system can use a trained classical learning model to process the measured values of the out-of-time-ordered correlator and predict properties of the quantum system. To train the classical learning model the system can generate, by a quantum computing device, training data by performing quantum simulations of the Hamiltonian that characterizes the quantum system. Each quantum simulation corresponds to respective Hamiltonian parameter values. The system can then train the classical learning model to predict properties of the quantum system using the training data.

In some implementations, before processing the measured values of the out-of-time-ordered correlator to determine properties of the quantum system, the system can compute the Fisher information for each measured value of the out-of-time-ordered correlator. The system can then identify one or more correlators that achieve a maximal Fisher information (or correlators with an amount of Fisher information that exceeds a predetermined threshold). The system can then repeat the measurements of the out-of-time-ordered correlator that correspond to the maximal Fisher information, where the repeated measurements are performed at a higher precision.

In some implementations, before processing the measured values of the out-of-time-ordered correlator to determine properties of the quantum system, the system can compute the mutual information between each measured out-of-time-ordered correlator values and the link strength. The system can then select a predetermined number measured out-of-time-ordered correlator values with the highest mutual information. The system can then provide the selected predetermined number of measured out-of-time-ordered correlator values for processing by the classical computing device.

FIG. 5 shows two plots 500, 550 for learning weak interactions in quantum systems. In both plots, it is assumed that access to a spin chain 502 with unknown Hamiltonian parameters and either no link interaction (Jₗ→0) or a fixed non-zero weak link interaction strength Jₗ is provided. In plot 500, for each fixed value of Jₗ, a binary SVM classifier was trained on the correlation functions (given by Eq. 2 and 3) of 300 disorder samples, including a read-out error of 3% in each correlator value, as described above with reference to FIG. 3. The model performance was tested on 200 additional samples. As shown in plot 500, the resulting classification accuracies exhibit the following trends: (i) the accuracy decreases as Jₗ decreases, (ii) learning via both OTOCs and TOCs allows detection of ˜10 times smaller Jₗ than learning via only TOCs, and (iii) OTOCs allow for the detection of increasingly small Jₗ as the size L of the chain increases.

To understand this behavior analytically, it is noted that the optimal correlation functions for detecting the link will typically involve operators lying immediately adjacent to that link, on both of its sides. These correlators measure either the transfer of spin polarization (for TOCs) or operator support (for OTOCs) across the link, and will be non-trivial only if the link interaction strength is nonzero. For TOCs, it is expected that spin polarization will cross the link incoherently, at a rate

$$\sim {J}_{l}^{2} / J ,$$

where J is the typical strong interaction strength. Combined with an overall exponential decay of spin in time (if the system has no conserved quantities), it is expected that

$${C}_{TOC} \sim ( \frac{{J}_{l}^{2}}{J} ) {te}^{- Jt} .$$

For OTOCs, it is expected that an operator's support cross the link at a similar rate.

$$1 - {C}_{OTOC} \sim ( \frac{{J}_{l}^{2}}{J} ) t .$$

However, this growth persists until much later times t˜L/J, at which information traveling around the chain will abruptly cause the OTOC to decay to zero. The optimal time for detecting the link occurs when these correlators are maximized, since each is zero in the absence of the link. The TOC is maximized at an order one time t˜1/J, at which the correlator magnitude

$${C}_{TOC} \sim ( \frac{{J}_{l}^{2}}{{J}^{2}} )$$

is suppressed by the square of the weak link interaction strength. In contrast, the OTOC is maximized at a much later time t˜L/J, and thereby features a magnitude

$$1 - {C}_{OTC} \sim L ( \frac{{J}_{l}^{2}}{{J}^{2}} ) .$$

In both cases it is seen that detection of the link becomes more difficult as the link strength decreases. Detection via the OTOC is enhanced by a factor of L, which captures the connectivity change associated with the link.

Plot 550 confirms these calculations quantitatively by computing the Fisher information of the link interaction strength. In plot 550, the maximum Fisher information

$${max}_{C} FI ( log ( {J}^{l} ) \vert C )$$

is plotted over all local correlation functions, averaged over 100 disorder realizations. Here, the logarithm of the link interaction strength is considered in order to appropriately compare the Fisher information over multiple orders of magnitude of the interaction. The Fisher information of log Jₗ bounds the learnability of the interaction strength as a percentage of its actual value. It is predicted that

$$FI \sim ( \frac{{J}_{l}^{4}}{{J}^{4}} )$$

### for TOCs and

$${( FI \sim L )}^{2} ( \frac{{J}_{l}^{4}}{{J}^{4}} )$$

for OTOCs. Plot 550 shows that the FI is suppressed by ˜J⁴ for small Jₗ and displays a multiplicative advantage for OTOCs compared to TOCs, which grows as L increases.

### Disjoint Unitary Problem

In the disjoint unitary problem, oracle access is given to either a (i) a fixed, n-qubit Haar-random unitary U, or (ii) a tensor product of two fixed, n/2-qubit Haar-random unitaries U₁⊗U₂. The task is to determine which of (i) or (ii) is realized. Qualitatively, this problem resembles the Hamiltonian learning scenarios identified above. First, the property of the system to be learned—the connectivity of the unitary—directly determines how information spreads through the system, as measured by the OTOC. Second, a Haar-random unitary is inherently strongly-interacting, which causes time-ordered measurements to decay and thus provide little information.

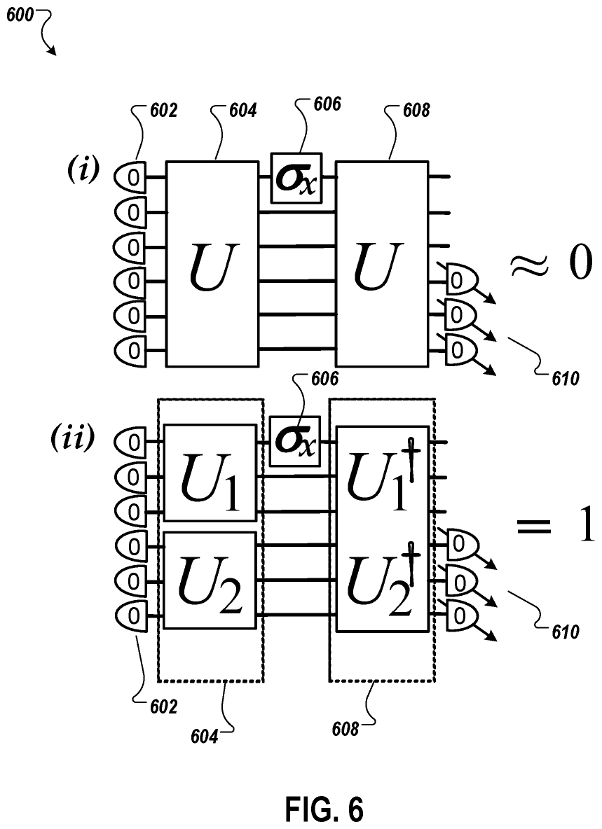

FIG. 6 is a circuit diagram 600 of a solution to the disjoint unitary problem using OTOC measurements. A register of qubits is prepared in the quantum state |0 [symbol] ^{⊗n} 602. The unknown unitary 604 (either U or U₁⊗U₂) is applied. Next, the operator σₓ 606 is applied to the first qubit, followed by the inverse 608 of the unknown unitary. Finally, it is determined (through measurement operations 610) whether the second block of n/2 qubits is in the all zero state. If so, then the hidden unknown unitary is U₁⊗U₂ as per case (ii). If not, then the unknown unitary is U as per case (i). As shown, the disjoint unitary problem can be solved with a constant number (with respect to n) of queries to the oracle and its time-reverse, by measuring the out-of-time-order observable:

$${{OTOC ( V ) = tr ( {𝕀}_{\frac{n}{2}} ⊗ \vert 0 〉 〈 0 \vert}^{⊗ \frac{n}{2}} \{ {V}^{†} {σ}_{x}^{1} V \vert 0 〉 〈 0 \vert}^{⊗ n} {V}^{†} {σ}_{x}^{1} V \} ) \qquad ( 5 )$$

where V represents the unknown unitary (either U or U₁⊗U₂)

$${𝕀}_{\frac{n}{2}}$$

represents the identity operator applied to the first block of n/2 qubits, and

$${σ}_{x}^{1}$$

represents the Pauli-X operator applied to the first qubit.

In case (i), the OTOC is near zero with probability exponentially close to one. In case (ii), the OTOC is one, since the two subsystems are not coupled by U₁⊗U₂. Thus, with probability exponentially close to one, the two cases can be distinguished with a single query to the unknown unitary and its time-reverse. In contrast, any time-ordered learning protocol requires an exponential number of queries of the unknown unitary to solve the disjoint unitary problem.

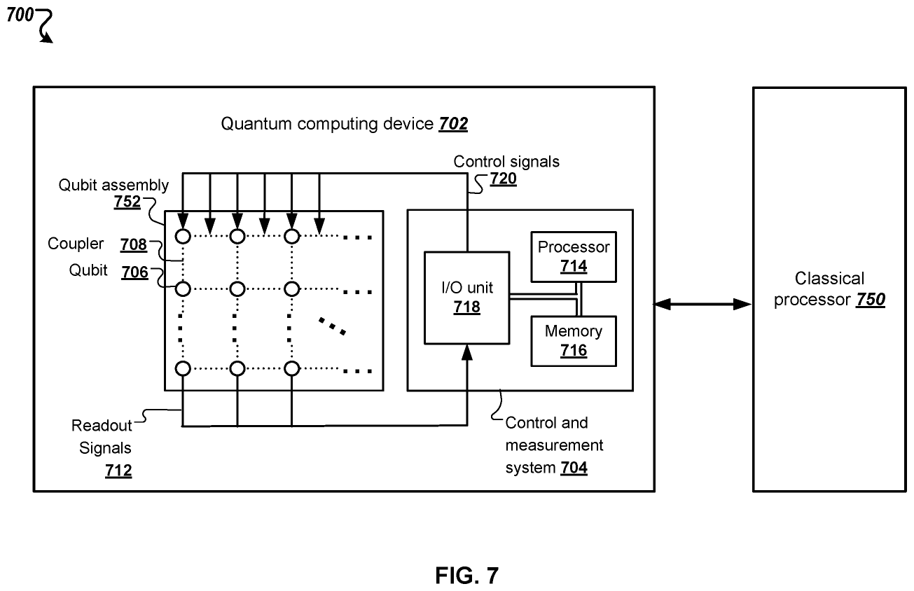

FIG. 7 depicts an example classical/quantum computer 700 for performing some or all of the classical and quantum operations described in this specification. The example classical/quantum computer 700 includes an example quantum computing device 702. The quantum computing device 702 is intended to represent various forms of quantum computing devices. The components shown here, their connections and relationships, and their functions, are exemplary only, and do not limit implementations of the inventions described and/or claimed in this document.

The example quantum computing device 702 includes a qubit assembly 752 and a control and measurement system 704. The qubit assembly includes multiple qubits, e.g., qubit 706, that are used to perform algorithmic operations or quantum computations. While the qubits shown in FIG. 7 are arranged in a rectangular array, this is a schematic depiction and is not intended to be limiting. The qubit assembly 752 also includes adjustable coupling elements, e.g., coupler 708, that allow for interactions between coupled qubits. In the schematic depiction of FIG. 7, each qubit is adjustably coupled to each of its four adjacent qubits by means of respective coupling elements. However, this is an example arrangement of qubits and couplers and other arrangements are possible, including arrangements that are non-rectangular, arrangements that allow for coupling between non-adjacent qubits, and arrangements that include adjustable coupling between more than two qubits.

Each qubit can be a physical two-level quantum system or device having levels representing logical values of 0 and 1. The specific physical realization of the multiple qubits and how they interact with one another is dependent on a variety of factors including the type of the quantum computing device 702 included in the example computer 700 or the type of quantum computations that the quantum computing device is performing. For example, in an atomic quantum computer the qubits may be realized via atomic, molecular or solid-state quantum systems, e.g., hyperfine atomic states. As another example, in a superconducting quantum computer the qubits may be realized via superconducting qubits or semi-conducting qubits, e.g., superconducting transmon states. As another example, in a NMR quantum computer the qubits may be realized via nuclear spin states.

In some implementations a quantum computation can proceed by loading qubits, e.g., from a quantum memory, and applying a sequence of unitary operators to the qubits. In some implementations the sequence of unitary operators can represent forward or backward time evolution. Applying a unitary operator to the qubits can include applying a corresponding sequence of quantum logic gates to the qubits. e.g., to implement a quantum algorithm such as a quantum principle component algorithm. Example quantum logic gates include single-qubit gates, e.g., Pauli-X, Pauli-Y, Pauli-Z (also referred to as X, Y, Z), Hadamard gates, S gates, rotations, two-qubit gates, e.g., controlled-X, controlled-Y, controlled-Z (also referred to as CX, CY, CZ), controlled NOT gates (also referred to as CNOT) controlled swap gates (also referred to as CSWAP), and gates involving three or more qubits. e.g., Toffoli gates. The quantum logic gates can be implemented by applying control signals 710 generated by the control and measurement system 704 to the qubits and to the couplers.

For example, in some implementations the qubits in the qubit assembly 752 can be frequency tunable. In these examples, each qubit can have associated operating frequencies that can be adjusted through application of voltage pulses via one or more drive-lines coupled to the qubit. Example operating frequencies include qubit idling frequencies, qubit interaction frequencies, and qubit readout frequencies. Different frequencies correspond to different operations that the qubit can perform. For example, setting the operating frequency to a corresponding idling frequency may put the qubit into a state where it does not strongly interact with other qubits, and where it may be used to perform single-qubit gates. As another example, in cases where qubits interact via couplers with fixed coupling, qubits can be configured to interact with one another by setting their respective operating frequencies at some gate-dependent frequency detuning from their common interaction frequency. In other cases, e.g., when the qubits interact via tunable couplers, qubits can be configured to interact with one another by setting the parameters of their respective couplers to enable interactions between the qubits and then by setting the qubit's respective operating frequencies at some gate-dependent frequency detuning from their common interaction frequency. Such interactions may be performed in order to perform multi-qubit gates.

The type of control signals 710 used depends on the physical realizations of the qubits. For example, the control signals may include RF or microwave pulses in an NMR or superconducting quantum computer system, or optical pulses in an atomic quantum computer system.

A quantum computation can be completed by measuring the states of the qubits, e.g., using a quantum observable such as X or Z, using respective control signals 710. The measurements cause readout signals 712 representing measurement results to be communicated back to the control and measurement system 704. The readout signals 712 may include RF, microwave, or optical signals depending on the physical scheme for the quantum computing device and/or the qubits. For convenience, the control signals 710 and readout signals 712 shown in FIG. 7 are depicted as addressing only selected elements of the qubit assembly (i.e. the top and bottom rows), but during operation the control signals 710 and readout signals 712 can address each element in the qubit assembly 752.

The control and measurement system 704 is an example of a classical computer system that can be used to perform various operations on the qubit assembly 752, as described above, as well as other classical subroutines or computations. The control and measurement system 704 includes one or more classical processors, e.g., classical processor 414, one or more memories, e.g., memory 716, and one or more I/O units, e.g., I/O unit 718, connected by one or more data buses. The control and measurement system 704 can be programmed to send sequences of control signals 710 to the qubit assembly, e.g. to carry out a selected series of quantum gate operations, and to receive sequences of readout signals 712 from the qubit assembly. e.g. as part of performing measurement operations.

The processor 714 is configured to process instructions for execution within the control and measurement system 704. In some implementations, the processor 714 is a single-threaded processor. In other implementations, the processor 714 is a multi-threaded processor. The processor 714 is capable of processing instructions stored in the memory 716.

The memory 716 stores information within the control and measurement system 704. In some implementations, the memory 716 includes a computer-readable medium, a volatile memory unit, and/or a non-volatile memory unit. In some cases, the memory 716 can include storage devices capable of providing mass storage for the system 704, e.g. a hard disk device, an optical disk device, a storage device that is shared over a network by multiple computing devices (e.g., a cloud storage device), and/or some other large capacity storage device.

The input/output device 718 provides input/output operations for the control and measurement system 704. The input/output device 718 can include D/A converters, A/D converters, and RF/microwave/optical signal generators, transmitters, and receivers, whereby to send control signals 710 to and receive readout signals 712 from the qubit assembly, as appropriate for the physical scheme for the quantum computer. In some implementations, the input/output device 718 can also include one or more network interface devices, e.g., an Ethernet card, a serial communication device, e.g., an RS-232 port, and/or a wireless interface device, e.g., an 802.11 card. In some implementations, the input/output device 718 can include driver devices configured to receive input data and send output data to other external devices, e.g., keyboard, printer and display devices.

Although an example control and measurement system 704 has been depicted in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them.

The example system 700 also includes an example classical processor 750. The classical processor 750 can be used to perform classical computation operations described in this specification according to some implementations.

Implementations of the subject matter and operations described in this specification can be implemented in digital electronic circuitry, analog electronic circuitry, suitable quantum circuitry or, more generally, quantum computational systems, in tangibly-embodied software or firmware, in computer hardware, including the structures disclosed in this specification and their structural equivalents, or in combinations of one or more of them. The term “quantum computational systems” may include, but is not limited to, quantum computers, quantum information processing systems, quantum cryptography systems, or quantum simulators.

Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, one or more qubits, or a combination of one or more of them. Alternatively or in addition, the program instructions can be encoded on an artificially-generated propagated signal that is capable of encoding digital and/or quantum information, e.g., a machine-generated electrical, optical, or electromagnetic signal, that is generated to encode digital and/or quantum information for transmission to suitable receiver apparatus for execution by a data processing apparatus.

The terms quantum information and quantum data refer to information or data that is carried by, held or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, multiple digital and quantum processors or computers, and combinations thereof. The apparatus can also be, or further include, special purpose logic circuitry, e.g., an FPGA (field programmable gate array), an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL or Quipper.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable computers, operating with one or more processors, as appropriate, executing one or more computer programs to perform functions by operating on input data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more computers to be “configured to” perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For example, a quantum computer may receive instructions from a digital computer that, when executed by the quantum computing apparatus, cause the apparatus to perform the operations or actions.

Computers suitable for the execution of a computer program can be based on general or special purpose processors, or any other kind of central processing unit. Generally, a central processing unit will receive instructions and data from a read-only memory, a random access memory, or quantum systems suitable for transmitting quantum data, e.g. photons, or combinations thereof.

The elements of a computer include a central processing unit for performing or executing instructions and one or more memory devices for storing instructions and digital, analog, and/or quantum data. The central processing unit and the memory can be supplemented by, or incorporated in, special purpose logic circuitry or quantum simulators. Generally, a computer will also include, or be operatively coupled to receive data from or transfer data to, or both, one or more mass storage devices for storing data, e.g., magnetic, magneto-optical disks, optical disks, or quantum systems suitable for storing quantum information. However, a computer need not have such devices.

Quantum circuit elements (also referred to as quantum computing circuit elements) include circuit elements for performing quantum processing operations. That is, the quantum circuit elements are configured to make use of quantum-mechanical phenomena, such as superposition and entanglement, to perform operations on data in a non-deterministic manner. Certain quantum circuit elements, such as qubits, can be configured to represent and operate on information in more than one state simultaneously. Examples of superconducting quantum circuit elements include circuit elements such as quantum LC oscillators, qubits (e.g., flux qubits, phase qubits, or charge qubits), and superconducting quantum interference devices (SQUIDs) (e.g., RF-SQUID or DC-SQUID), among others.

In contrast, classical circuit elements generally process data in a deterministic manner. Classical circuit elements can be configured to collectively carry out instructions of a computer program by performing basic arithmetical, logical, and/or input/output operations on data, in which the data is represented in analog or digital form. In some implementations, classical circuit elements can be used to transmit data to and/or receive data from the quantum circuit elements through electrical or electromagnetic connections. Examples of classical circuit elements include circuit elements based on CMOS circuitry, rapid single flux quantum (RSFQ) devices, reciprocal quantum logic (RQL) devices and ERSFQ devices, which are an energy-efficient version of RSFQ that does not use bias resistors.

In certain cases, some or all of the quantum and/or classical circuit elements may be implemented using, e.g., superconducting quantum and/or classical circuit elements. Fabrication of the superconducting circuit elements can entail the deposition of one or more materials, such as superconductors, dielectrics and/or metals. Depending on the selected material, these materials can be deposited using deposition processes such as chemical vapor deposition, physical vapor deposition (e.g., evaporation or sputtering), or epitaxial techniques, among other deposition processes. Processes for fabricating circuit elements described herein can entail the removal of one or more materials from a device during fabrication. Depending on the material to be removed, the removal process can include, e.g., wet etching techniques, dry etching techniques, or lift-off processes. The materials forming the circuit elements described herein can be patterned using known lithographic techniques (e.g., photolithography or e-beam lithography).

During operation of a quantum computational system that uses superconducting quantum circuit elements and/or superconducting classical circuit elements, such as the circuit elements described herein, the superconducting circuit elements are cooled down within a cryostat to temperatures that allow a superconductor material to exhibit superconducting properties. A superconductor (alternatively superconducting) material can be understood as material that exhibits superconducting properties at or below a superconducting critical temperature. Examples of superconducting material include aluminum (superconductive critical temperature of 1.2 kelvin) and niobium (superconducting critical temperature of 9.3 kelvin). Accordingly, superconducting structures, such as superconducting traces and superconducting ground planes, are formed from material that exhibits superconducting properties at or below a superconducting critical temperature.

In certain implementations, control signals for the quantum circuit elements (e.g., qubits and qubit couplers) may be provided using classical circuit elements that are electrically and/or electromagnetically coupled to the quantum circuit elements. The control signals may be provided in digital and/or analog form.

Computer-readable media suitable for storing computer program instructions and data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a computer program product that includes instructions that are stored on one or more non-transitory machine-readable storage media, and that are executable on one or more processing devices. The systems described in this specification, or portions of them, can each be implemented as an apparatus, method, or system that may include one or more processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
measuring, by a control and measurement system, an out-of-time-ordered correlator value for a quantum system comprising a plurality of qubits, wherein the plurality of qubits comprises a probe qubit and one or more other qubits, the measuring comprising:
preparing the probe qubit in an initial state,
performing forward time evolution on the quantum system for a time t,
applying a unitary operator to one or more qubits in the quantum system,
performing backward time evolution on the quantum system for the time t, and
measuring the probe qubit to obtain the out-of-time-ordered correlator value; and
processing, by a classical computing device, the measured out-of-time-ordered correlator value to determine properties of the quantum system.

2. The method of claim 1, wherein the measured out-of-time-ordered correlator value indicates whether information encoded at the probe qubit at an initial time is contained in correlations involving the other qubits at time t.

3. The method of claim 1, further comprising, for each of multiple values of t and for each of multiple unitary operators, repeatedly measuring the out-of-time-ordered correlator value.

4. The method of claim 3, wherein processing the measured out-of-time-ordered correlators values to determine properties of the quantum system comprises using a trained classical learning model to predict the properties of the quantum system.

5. The method of claim 4, further comprising:
generating, by a quantum computer, training data, the generating comprising performing quantum simulations of a Hamiltonian that characterizes the quantum system, each quantum simulation corresponding to respective Hamiltonian parameter values; and
training the classical learning model to predict properties of the quantum system using the training data.

6. The method of claim 3, further comprising:
measuring the out-of-time-ordered correlator value for each of multiple values of t and for each of multiple unitary operators, wherein the measurements are performed at a first precision;
computing Fisher information for each measured out-of-time-ordered correlator value; and
repeating measurement of the out-of-time-ordered correlator values with maximal Fisher information, wherein the repeated measurements are performed at a second precision that is higher than the first precision.

7. The method of claim 1, wherein the unitary operator comprises a local unitary operator, optionally a single qubit Pauli operation.

8. The method of claim 1, wherein the unitary operator comprises a global rotation operation.

9. The method of claim 1, wherein the quantum system comprises an ergodic 1D spin chain, and wherein determining properties of the quantum system comprises learning a qubit coupling at a distance d from the probe qubit.

10. The method of claim 1, wherein the quantum system comprises two spin chains that intersect at a distance d from the probe qubit, and wherein determining properties of the quantum system comprises learning the value of d.

11. The method of claim 1, wherein performing forward time evolution on the quantum system for a time t comprises applying a quantum circuit to the quantum system that implements a second unitary operator e^{-iHt}, wherein H represents a Hamiltonian that characterizes the quantum system, and wherein performing backward time evolution on the quantum system for the time t comprises applying a quantum circuit to the quantum system that implements a third unitary operator e^{iHt}.

12. The method of claim 1, wherein performing backward time evolution on the quantum system for the time t is noisy.

13. A method comprising:
measuring, by a control and measurement system, an out-of-time-ordered correlator value for a quantum system comprising a plurality of interacting qubits, the measuring comprising:
preparing a first qubit and a second qubit in the quantum system in an initial state, wherein the first qubit is adjacent to the second qubit,
performing forward time evolution on the quantum system for a time t,
applying a unitary operator to the first qubit,
performing backward time evolution on the quantum system for the time t, and
measuring the first qubit and the second qubit to obtain the out-of-time-ordered correlator value; and
processing, by a classical computing device, the measured out-of-time-ordered correlator value to determine properties of the quantum system.

14. The method of claim 13, wherein the measured out-of-time-ordered correlator value indicates whether information encoded at the first qubit at an initial time is contained in correlations involving other qubits at time t.

15. The method of claim 13, further comprising, for each of multiple values of t and for each of multiple pairs of qubits in the quantum system, repeatedly measuring the out-of-time-ordered correlator value.

16. The method of claim 15, wherein processing the measured out-of-time-ordered correlator values to determine properties of the quantum system comprises using a trained classical learning model to predict the properties of the quantum system.

17. The method of claim 16, further comprising:
generating, by a quantum computer, training data, the generating comprising performing quantum simulations of a Hamiltonian that characterizes the quantum system, each quantum simulation corresponding to respective Hamiltonian parameter values; and
training the classical learning model to predict properties of the quantum system using the training data.

18. The method of claim 15, further comprising:
measuring the out-of-time-ordered correlator value for each of multiple values of t and for each of multiple pairs of qubits, wherein the measurements are performed at a first precision;
computing Fisher information for each measured out-of-time-ordered correlator value; and
repeating measurement of the out-of-time-ordered correlator values with maximal Fisher information, wherein the repeated measurements are performed at a second precision that is higher than the first precision.

19. The method of claim 13, wherein the quantum system comprises a strongly interacting system.

20. The method of claim 19, wherein the quantum system comprises a 1D spin chain, and wherein determining properties of the quantum system comprises characterizing a weak link interaction known to exist in the spin chain.

21. The method of claim 20, further comprising repeatedly measuring the out-of-time-ordered correlator value for pairs of qubits that are within a predetermined distance from the weak link interaction.

22. The method of claim 20, further comprising, prior to processing the measured out-of-time-ordered correlator values:
computing mutual information between each measured out-of-time-ordered correlator values and link strength;
selecting a predetermined number of measured out-of-time-ordered correlator values with the highest mutual information; and
providing the predetermined number of measured out-of-time-ordered correlator values for processing by the classical computing device.

23. The method of claim 13, wherein the quantum system comprises a 1D spin chain, and wherein determining properties of the quantum system comprises predicting whether the spin chain includes or excludes a weak link interaction.

24. The method of claim 13, wherein performing backward time evolution on the quantum system for the time t is noisy.

25. The method of claim 13, wherein performing forward time evolution on the quantum system for a time t comprises applying a quantum circuit to the quantum system that implements a second unitary operator e^{-iHt}, wherein H represents a Hamiltonian that characterizes the quantum system, and wherein performing backward time evolution on the quantum system for the time t comprises applying a quantum circuit to the quantum system that implements a third unitary operator e^{iHt}.

26. A system comprising:
a control and measurement system; and
a classical computing device coupled to the control and measurement system, wherein the classical computing device comprises computer-readable media having instructions stored thereon which, when executed by the classical computing device, cause the control and measurement system and classical computing device to perform operations comprising:
measuring, by a control and measurement system, an out-of-time-ordered correlator value for a quantum system comprising a plurality of qubits, wherein the plurality of qubits comprises a probe qubit and one or more other qubits, the measuring comprising:
preparing the probe qubit in an initial state,
performing forward time evolution on the quantum system for a time t,
applying a unitary operator to one or more qubits in the quantum system,
performing backward time evolution on the quantum system for the time t, and
measuring the probe qubit to obtain the out-of-time-ordered correlator value; and
processing, by a classical computing device, the measured out-of-time-ordered correlator value to determine properties of the quantum system.
